(19) United States
(12) Patent Application Publication
(10) Pub. No.: US 2023/0286198 A1
(43) Pub. Date: Sep. 14, 2023

(54) ECO-FRIENDLY THERMOPLASTIC POLYURETHANE FLOORING MATERIAL HAVING EXCELLENT DIMENSIONAL STABILITY AND ABRASION RESISTANCE, AND MANUFACTURING METHOD THEREFOR

(71) Applicant: SEHWA ADVANCED MATERIAL CO., LTD., Gwangju (KR)

(72) Inventors: Woo Sang Kim, Gwangju (KR); Hae Cheon KANG, Gimpo-si (KR)

(21) Appl. No.: 17/048,825

(22) PCT Filed: Aug. 30, 2019
(86) PCT No.: PCT/KR2019/011103

§ 371 Date: Oct. 19, 2020

(30) Foreign Application Priority Data
Oct. 18, 2018 (KR) 10-2018-0124723

(51) Int. Cl. B29C 48/21; B29C 48/00

(52) U.S. Cl. CPC B29C 48/21; B29C 48/022; B29K 2075/00

(57) ABSTRACT

Provided is an eco-friendly structural flooring material including a surface-treated layer, a surface layer including a print layer, a core layer, and a balance layer which are consecutively laminated from the top, wherein the surface-treated layer, the surface layer containing the print layer, the core layer, and the balance layer are made of a thermoplastic polyurethane resin layer.

### CROSS-REFERENCE TO RELATED APPLICATIONS

This application claims priority to PCT Application No. PCT/KR2019/011103, having a filing date of Aug. 30, 2019, based on KR 10-2018-0124723, having a filing date of Oct. 18, 2018, the entire contents both of which are hereby incorporated by reference.

### FIELD OF TECHNOLOGY

The following relates to an eco-friendly thermoplastic polyurethane (TPU) flooring material having excellent dimensional stability and abrasion resistance and a manufacturing method thereof, and more particularly, to an eco-friendly TPU flooring material containing a TPU resin, silicone gum, and the like and having excellent abrasion resistance and dimensional stability. In addition, the following relates to an eco-friendly TPU flooring material having excellent contamination resistance and mechanical properties and a manufacturing method thereof.

### BACKGROUND

Polyvinyl chloride (PVC) resin is the most widely used synthetic resin flooring material among commonly used interior finishing materials. Although PVC resin has excellent processability and is widely used in various fields, because PVC resin contains chlorine (CO, not only a large amount of smoke and chlorine gas are generated during combustion, which are lethal to the human body, but also a large amount of a harmful substance that may cause serious damage to the human body, dioxin, is released. In addition, when processing a PVC resin material into a flooring material, a phthalate plasticizer (DOP) is added to the flooring material. However, phthalate plasticizers are endocrine disrupting substances widely known as so-called environmental hormones and have a great negative impact on human safety, and since the phthalate plasticizers produce dioxins when incinerated and release volatile organic compounds (VOCs) and formaldehyde (HCHO), which are toxic substances that cause sick house syndrome, there is a growing demand for improvement of problems with phthalate plasticizers. Accordingly, for all flooring products manufactured using PVC resin, the Korean Agency for Technology and Standards (KATS) under the Ministry of Trade, Industry and Energy issued a KATS notice in July 2013 in accordance with the Quality Control and Safety Management of Industrial Products Act and has regulated the content of phthalate plasticizers.

Accordingly, in keeping with the recent eco-friendly trend, the demand for the development of interior finishing materials harmless to the human body is increasing rapidly, and there is a trend of using eco-friendly materials for interior finishing materials such as wood-based flooring materials, synthetic resin flooring materials, tiles, wallpaper, and carpets.

To replace the PVC resin, it is necessary to secure source technology for processing a non-PVC-based eco-friendly resin, such as ethylene-vinyl acetate (EVA), low-density polyethylene (LDPE), high-density polyethylene (HDPE), TPU, and polypropylene (PP), which are harmless to the human body. In addition, there is an urgent need to develop a non-PVC flooring material considering main properties required for structural flooring materials, such as elasticity, abrasion resistance, printability, flame retardancy, and dimensional stability. Among these materials, TPU is frequently researched and developed in the industrial and home interior fields due to its excellent elasticity, which is one of the main properties required.

Currently, in the case of general PVC flooring materials, although an ultraviolet (UV)-curable resin coating with a small thickness of about 10 μm to 20 μm is applied to an upper transparent layer to improve abrasion resistance, the coating wears out easily and does not last long. Additionally, multi-layer PVC flooring materials have dimensional stability issues in that due to general environmental factors such as external temperature and humidity and the difference in the coefficient of thermal expansion of sheets, the flooring material is distorted, expanded, or shrunk and thus cannot be used stably. In order to solve the problems, a method of inserting a fiberglass sheet, which is another type of material, to increase dimensional stability or a method of adding a large amount of inorganic filler to lower the thermal expansion coefficient of PVC resin has been used. However, when a fiberglass sheet is used, the fiberglass sheet cannot be recycled by extrusion or calendering, and when a large amount of inorganic filler is added, since the bond strength of the PVC resin layer decreases, the PVC resin layer may be bent or broken due to impact, and weight increases, greatly reducing the ease of handling during transportation, ease of installation, and the like.

To solve the social, environmental, and quality issues described above, various methods have been applied to improve the processing and formulation of PVC resin, but the limitations of the properties of PVC resin make it difficult to fundamentally solve these problems.

Although, recently, decorative flooring materials in which all of the constituent layers are made of polyolefin resin have been developed, due to the difficulty of processing polyolefin-based materials, there is a limit to satisfying the properties required for a flooring material, and special manufacturing techniques are required.

In order to improve the harm to the human body caused by the use of the above-described PVC resin flooring material, Korean Patent Registration No. 10-0908661 discloses an eco-friendly flooring material, which contains a material based on a copolymer containing propylene and ethylene and a thermoplastic polyolefin, and a manufacturing method thereof.

However, although the eco-friendly flooring material manufactured according to the above-described registered patent uses a non-toxic polyolefin-based resin as a flooring material and can be a safe material that does not expose the human body to the risk of accidents or to harmful substances by not producing chlorine gas or smoke in the event of a fire or generating VOCs or HCHO, which are toxic substances that cause sick house syndrome, since all of the surface layer, pattern layer, and base layer making up the flooring material are made of the same sheet material based on a copolymer containing propylene and ethylene and a thermoplastic polyolefin and lamination by thermocompression is not possible due to the non-polar nature of the molecules, it is required that an additional adhesive layer is applied. However, the use of adhesives is often unhealthy due to the harmful organic compounds contained therein, and since drying and bonding of the adhesive requires at least 48 hours of aging, a separate space is required for aging. In addition, due to the nature of the material, the surface durability, transparency, flexibility, and flexural strength of the finished product are low, so there is a problem in using the finished product as a flooring material, and since the material is non-polar, there is a problem with installation due to low adhesion to the floor surface of a building. In addition, since the flooring material is produced in an intermittent process using press equipment after sequentially laminating semi-finished products, productivity and work efficiency are significantly lowered, resulting in increased manufacturing costs, reduced production, and ultimately, reduced market competitiveness.

In addition, Korean Patent Registration No. 10-1395714 discloses a flooring material including a UV coating layer, an overlay, a dimensional reinforcing layer, a foam layer, and an underlayer made of polyolefin resin. However, the flooring material has a problem in that although the use of polyolefin resin adds eco-friendliness, the polyolefin resin used for the overlay has very low abrasion resistance compared to conventional PVC, and the dimensional reinforcing layer is made using thermosetting urethane resin-impregnated fiberglass, which is another type of material, and thermosetting urethane resin-impregnated fiberglass cannot be recycled by extrusion after being discarded.

In addition, Korean Patent Registration No. 10-1627732 discloses a non-PVC recyclable eco-friendly flooring material in which a surface layer sheet, a printed layer sheet, and a back layer sheet are sequentially laminated. In this case, the use of TPU resin adds recyclability and eco-friendliness, but it is generally very difficult to improve flame retardancy using conventional TPU resin. This is because when exposed to high-temperature heat, the TPU resin is usually depolymerized into low-molecular-weight monomers having higher flammability, resulting in heat generation. In addition, when the TPU resin is formed using a polyether polyol, the mechanical properties and abrasion resistance of polyurethane are significantly degraded, resulting in low abrasion resistance compared to that of conventional PVC, and since flame retardancy, abrasion resistance, and contamination resistance are low, it is difficult to satisfy the required properties of a structural flooring material.

In addition, since the flooring material is designed in a multi-layered structure in which a printed layer is manufactured by printing using a separate printing film layer and then thermally laminated onto a surface layer film, it is difficult to maintain a structural balance between the layers, and due to the complexity of the manufacturing process, a long preparation time, and difficulty in obtaining semi-finished products, economical efficiency in terms of cost decreases.

In addition, since the flooring material is manufactured by a method of laminating the semi-products in multiple layers and then cooling the final finished product in a cooling water bath or a method of passing the finished product through a cooling drum to reduce thermal deformation between layers, the surface layer and the back layer are cooled to the same temperature, and since the surface layer and the back layer having different coefficients of thermal expansion have problems such as deformation, expansion, and shrinkage, it is difficult to stably maintain quality.

Therefore, there is an urgent need for an eco-friendly flooring material which is manufactured using eco-friendly TPU resin that is harmless to the human body, does not fundamentally generate harmful substances such as environmental hormones and dioxins, which are problems of PVC resin-based flooring materials manufactured with existing techniques, and eliminates the risk of sick house syndrome caused by plasticizers, and a manufacturing method thereof which enables the design of a TPU resin composition capable of securing a finished product having excellent abrasion resistance, dimensional stability, flexibility, anti-curling properties, contamination resistance, and the like and ensures excellent productivity, workability, and ease of installation.

### SUMMARY

An aspect relates to eliminating causes of social and environmental problems with the existing decorative flooring materials manufactured using PVC resin, realizing excellent dimensional stability and abrasion resistance, and improving cost competitiveness by improving the simplicity and efficiency of a process by designing a flooring material structure in which three or four layers of eco-friendly semi-finished products are laminated. In addition, embodiments of the present invention is directed to providing an eco-friendly TPU flooring material made of an eco-friendly material that is recyclable by extrusion or calendering after use and a manufacturing method thereof.

The above-described objectives of embodiments of the present invention are achieved by a TPU flooring material having excellent dimensional stability and abrasion resistance and a manufacturing method thereof.

The flooring material is a polyurethane flooring material in which a surface layer including a surface-treatment layer and a printed layer, a core layer, and a balance layer are sequentially laminated, wherein the surface layer includes a TPU resin having a Shore hardness of 90A to 120A and a softening point of 60° C. to 100° C., and one or more selected from the group consisting of ultra-high-molecular-weight polyethylene (UHMWPE) having a molecular weight of 1,000,000 to 5,000,000 and silicone gum, and each of the core layer and the balance layer contains a TPU resin including a Shore hardness of 90A to 120A and a softening point of 60° C. to 100° C., a flame retardant, and an inorganic material.

The TPU resin is one or more selected from the group consisting of an ester-based TPU resin, an ether-based TPU resin, and a carbonate-based TPU resin.

The surface layer includes one or more selected from the group consisting of UHMWPE and silicone gum at 1 part by weight to 10 parts by weight relative to 100 parts by weight of the TPU resin, and additionally includes a UV absorber at 1 part by weight to 5 parts by weight relative to 100 parts by weight of the TPU resin.

The UV absorber is one or more selected from the group consisting of benzotriazole, benzophenone, and formamidine.

The printed layer is printed directly on one side of the surface layer using an ink containing a water-based polyurethane component.

The surface-treatment layer is formed of a water-based polyurethane resin having a solid content of 30% to 40% and a viscosity of 10 cPs to 200 cPs.

The silicone gum is one or more selected from the group consisting of methyl gum, hydroxyl gum (OH-gum), and vinyl gum.

The surface layer includes an UHMWPE resin at 1 part by weight to 5 parts by weight and silicone gum at 1 part by weight to 5 parts by weight relative to 100 parts by weight of the TPU resin.

The core layer includes an inorganic material at 100 parts by weight to 250 parts by weight, a flame retardant at 3 parts by weight to 15 parts by weight, and a lubricant at 1 part by weight to 3 parts by weight relative to 100 parts by weight of the TPU resin.

The balance layer includes an inorganic material at 50 parts by weight to 100 parts by weight and a flame retardant at 3 parts by weight to 15 parts by weight relative to 100 parts by weight of the TPU resin. The method of manufacturing a polyurethane flooring material includes: forming a surface layer including a TPU resin (S11); forming a printed layer by printing a pattern directly on one side of the surface layer (S12); forming a surface-treatment layer by applying a water-based polyurethane coating on the other side of the surface layer (S13); forming a core layer including a TPU resin (S14); forming a balance layer including a TPU resin (S15); producing a semi-finished product by sequentially winding the surface layer including the surface-treatment layer and the printed layer, the core layer, and the balance layer into rolls and then continuously thermally laminating the layers by emboss lamination (S16); and aging the semi-finished product by passing the semi-finished product through an aging region in the form of a plate-shaped belt press of which temperature is adjustable and cooling the semi-finished product (S17).

The aging region includes a first zone having a temperature range of 80° C. to 100° C., a second zone having a temperature range of 60° C. to 80° C., and a third zone having a temperature range of 20° C. to 40° C., which are sequentially arranged.

An eco-friendly TPU structural flooring material of embodiments of the present invention does not generate harmful substances such as environmental hormones and dioxins and toxic substances such as VOCs and HCHO and thus is harmless to the human body unlike existing flooring materials based on PVC. In addition, due to including silicone gum or UHMWPE having excellent abrasion resistance and being manufactured using equipment with a cooling system including an aging region in the form of a plate-shaped belt press in which temperatures of upper and lower regions are adjustable, the eco-friendly TPU structural flooring material of embodiments of the present invention has excellent dimensional stability and abrasion resistance, and the eco-friendly TPU structural flooring material of embodiments of the present invention is made of eco-friendly non-PVC material that can be recycled by extrusion or calendering after being discarded after use and thus has further improved economic efficiency and eco-friendliness. In addition, according to embodiments of the present invention, it is possible to provide an eco-friendly TPU flooring material which has excellent contamination resistance, flexibility, and mechanical properties and can be continuously processed by emboss lamination and thus has improved productivity and work efficiency.

### BRIEF DESCRIPTION

Some of the embodiments will be described in detail, with reference to the following figures, wherein like designations denote like members, wherein:

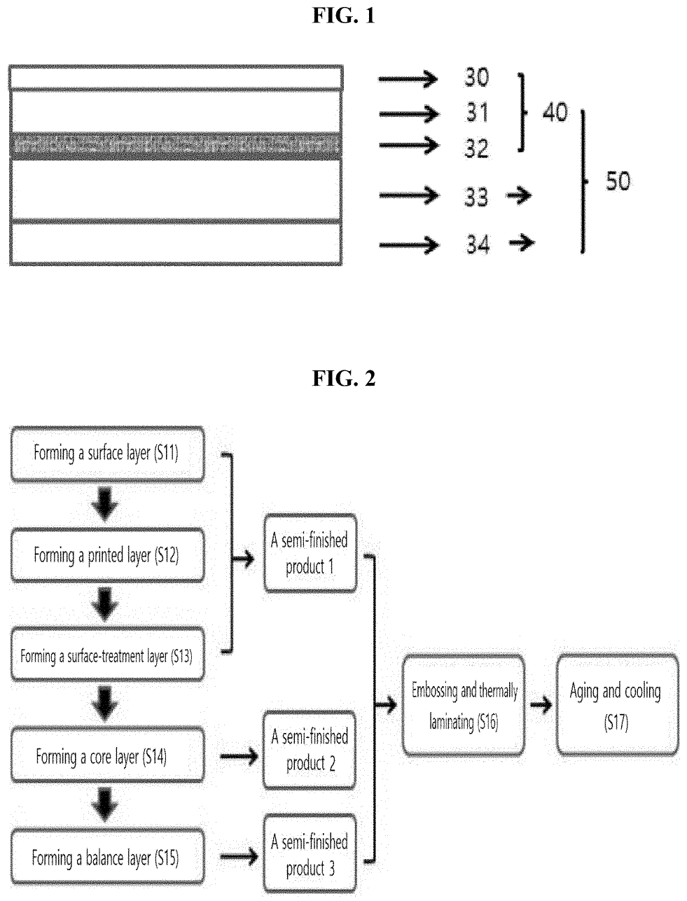

FIG. 1 is a cross-sectional view of an eco-friendly TPU flooring material according to one exemplary embodiment of the present invention; and

FIG. 2 is a process flow illustrating a method of manufacturing an eco-friendly TPU flooring material according to one exemplary embodiment of the present invention.

### DETAILED DESCRIPTION

Hereinafter, specific exemplary embodiments of the present invention will be described in detail with reference to the accompanying drawings so that those of ordinary skill in the art can easily implement embodiments of the present invention. However, the exemplary embodiments are merely illustrative of the present invention, and embodiments of the present invention are not limited thereto.

In an eco-friendly TPU flooring material of embodiments of the present invention, a surface layer including a surface-treatment layer and a printed layer on different sides thereof, a core layer, and a balance layer are sequentially laminated. FIG. 1 is a cross-sectional view of an eco-friendly TPU flooring material according to one exemplary embodiment of the present invention.

In the eco-friendly TPU flooring material of embodiments of the present invention, the surface layer including the surface-treatment layer and the printed layer, the core layer, and the balance layer are formed as TPU resin layers.

Since the TPU resins of the layers are TPU resins having specific shore hardness and softening point ranges, and the flooring material is manufactured by continuously thermally laminating the layers with thermal lamination equipment which enables continuous processing and includes a cooling system including an aging region in the form of a plate-shaped belt press in which temperatures of upper and lower regions are adjustable, productivity can be improved while a defect rate is reduced and thus economic efficiency can be excellent, and a flooring material having excellent abrasion resistance and dimensional stability can be manufactured.

Hereinafter, each of the layers will be described in detail.

The surface-treatment layer is formed on an upper surface of the surface layer to prevent the property degradation and aging of the flooring material, prevent the contamination and scratching of the flooring material, and facilitate cleaning. For the surface-treatment layer, one or more selected among an unsaturated polyester resin-based material, an epoxy acrylate-based material, a urethane acrylate-based material, a polyurethane-based material, and a polyester acrylate-based material may be selected and used.

The surface-treatment layer includes a water-based polyurethane resin having a solid content of 30 to 40% and a viscosity of 10 to 200 cPs.

The surface layer is formed on an upper surface of the printed layer to finish a surface of the flooring material. The surface layer may be formed of a TPU resin having a Shore hardness of 90A to 120A and a softening point of 60° C. to 100° C. and may include an additive resin having excellent abrasion resistance at 3 parts by weight to 10 parts by weight relative to 100 parts by weight of the TPU resin and a UV absorber at 1 part by weight to 5 parts by weight relative to 100 parts by weight of the TPU resin.

For example, the TPU resin may have a Shore hardness of 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, or 120A. For example, the TPU resin may have a softening point of 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100° C.

In this case, as the additive resin having excellent abrasion resistance, one or more selected from the group consisting of UHMWPE and silicone gum may be used. The UHMWPE resin has a non-polar group in the molecular structure thereof and thus has a low surface energy level. When added as an additive in the processing of the flooring material of embodiments of the present invention, the UHMWPE resin forms a weak boundary layer at the surface of the TPU resin, which is the main base resin, resulting in excellent self-lubricating properties and thereby stabilizing friction occurring at the surface layer, and greatly improves abrasion resistance by reducing the coefficient of friction and a wear rate. As the UHMWPE resin, one or more selected from UHMWPE resins having a molecular weight between 1,000,000 and 5,000,000 may be used. For example, the UHMWPE resin may have a molecular weight of 1,000,000, 1,500,000, 2,000,000, 2,500,000, 3,000,000, 3,500,000, 4,000,000, 4,500,000, or 5,000,000. In addition, the silicone gum has excellent self-lubricating properties, dispersibility, and heat resistance due to having a methacryloxy group, and thus is capable of improving abrasion resistance and scratch resistance by improving friction resistance. As the silicone gum, one or more selected from the group consisting of methyl gum, hydroxyl gum (OH-gum), and vinyl gum may be used.

In addition, the surface layer may include a UV absorber in addition to the above-described resin to improve light resistance. As the UV absorber, one or more selected from the group consisting of a benzotriazole-based UV absorber, a benzophenone-based UV absorber, and a formamidine-based UV absorber may be used. Such UV absorbers fundamentally block the photo-oxidation mechanisms of polymers by absorbing UV rays in place of the light-absorption end groups of the polymers and prevent aging caused by heat by releasing the absorbed UV rays in the form of harmless thermal energy (i.e., infrared rays). Since general polyurethane has very low light resistance at a wavelength of 290 nm to 330 nm as compared to other polymer compounds, it is desirable to use a UV absorber.

In embodiments of the present invention, the surface layer includes the additive resin having excellent abrasion resistance at 3 parts by weight to 10 parts by weight relative to 100 parts by weight of the TPU resin and the UV absorber at 1 part by weight to 5 parts by weight relative to 100 parts by weight of the TPU resin. However, when an excessive amount of the additive resin having excellent abrasion resistance is added, the transparency of the TPU resin may be lowered, and thus it may be advantageous to add the additive resin in the amount of 3 parts by weight to 5 parts by weight. For example, the additive resin having excellent abrasion resistance may be included in the surface layer in the amount of 3, 4, 5, 6, 7, 8, 9, or 10 parts by weight.

In addition, when an excessive amount of the UV absorber is added, the properties of the TPU resin may be degraded, so it may be more advantageous to add the UV absorber in the amount of 1 part by weight to 3 parts by weight relative to 100 parts by weight of the TPU resin. For example, the UV absorber may be included in the surface layer in the amount of 1, 2, 3, 4, or 5 parts by weight.

The printed layer is formed by printing the printed layer directly on one side of the surface layer using an ink containing a water-based polyurethane component, without using a separate printing film layer.

The core layer and the balance layer are bottom finish layers of the flooring material used for adjusting the thickness of the flooring material, imparting characteristics such as cushioning, walking comfort, shock absorption, mechanical properties, and dimensional stability to the flooring material, controlling and balancing the curling and doming of the flooring material, preventing deformation due to floor moisture after installation, and improving adhesion to a building floor surface.

Each of the core layer and the balance layer includes a TPU resin having a Shore hardness of 90A to 120A and a softening point of 60° C. to 100° C., a flame retardant, and an inorganic material. Each of the core layer and the balance layer includes the flame retardant at 3 parts by weight to 15 parts by weight relative to 100 parts by weight of the TPU resin, and the flame retardant is one or more selected from the group consisting of magnesium hydroxide (Mg(OH)₂), aluminum hydroxide (Al(OH)₃), and antimony trioxide (Sb₂O₃). The flame retardant serves to reduce the amount of heat of combustion by generating water and thus is capable of eventually increasing an oxygen index of the TPU. For example, the flame retardant may be included in the core layer and the balance layer at 3, 4, 5, 6, 7, 8, 9, 10, 11, 12, 13, 14, or 15 parts by weight relative to 100 parts by weight of the TPU resin.

For example, the TPU resin may have a Shore hardness of 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, or 120A. For example, the TPU resin may have a softening point of 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100° C.

The inorganic material is contained in the each of the core layer and the balance layer at 50 parts by weight to 150 parts by weight relative to 100 parts by weight of the TPU resin and is one or more selected from the group consisting of calcium carbonate, talc, silica, alumina, zinc oxide, and mica. For example, the inorganic material may be included in the each of the core layer and the balance layer at 50, 60, 70, 80, 90, 100, 110, 120, 130, 140, or 150 parts by weight.

In embodiments of the present invention, the core layer may include 50 wt % to 100 wt % more inorganic material than the weight of the inorganic material contained in the balance layer. The core layer may include the inorganic material at 25 parts by weight to 300 parts by weight relative to 100 parts by weight of the TPU resin. For example, the inorganic material may be included in the core layer at 25, 30, 40, 50, 60, 70, 80, 90, 100, 110, 120, 130, 140, 150, 160, 170, 180, 190, 200, 210, 220, 230, 240, 250, 260, 270, 280, 290, or 300 parts by weight.

In this case, it is desirable to add a lubricant at 1 part by weight to 5 parts by weight relative to 100 parts by weight of the TPU resin to increase extrusion moldability, and the lubricant is one or more selected from the group consisting of paraffin wax, a process oil, a vegetable oil, and stearic acid. For example, the lubricant may be included in the core layer at 1, 2, 3, 4, or 5 parts by weight.

The following is the description of a manufacturing method of an eco-friendly TPU flooring material having excellent dimensional stability and abrasion resistance according to embodiments of the present invention.

Specifically, the surface layer, the core layer, and the balance layer may be formed by T-die extrusion or calendering, and the surface-treatment layer and the printed layer may be formed by a gravure coating method.

More specifically, a method of manufacturing an eco-friendly TPU flooring material having excellent dimensional stability and abrasion resistance according to embodiments of the present invention includes: forming a surface layer including a TPU resin (S11); forming a printed layer by printing a pattern directly on one side of the surface layer (S12); forming a surface-treatment layer after applying a water-based polyurethane treatment agent coating on an upper surface of the printed surface layer (S13); forming a core layer including a TPU resin (S14); forming a balance layer including a TPU resin (S15); producing a semi-finished product by sequentially winding the surface layer including the surface-treatment layer and the printed layer, the core layer, and the balance layer into rolls and then continuously thermally laminating the layers by emboss lamination (S16); and aging and cooling the semi-finished product by passing the same through an aging region in the form of a plate-shaped belt press of which temperature is adjustable (S17). In step S11 of forming a surface layer, a TPU resin having a Shore hardness of 90A to 120A and a softening point of 60° C. to 100° C. is included. For example, the TPU resin may have a Shore hardness of 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, or 120A. For example, the TPU resin may have a softening point of 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100° C.

In embodiments of the present invention, as the TPU resin, one or more selected from the group consisting of an ester-based TPU resin, an ether-based TPU resin, a carbonate-based TPU resin, and the like may be used, and an ester-based TPU resin, which has relatively high abrasion resistance, is used.

The surface layer 31 of embodiments of the present invention may have a thickness of 100 μm to 300 μm, but embodiments of the present invention are not particularly limited thereto. When the thickness of the surface layer 31 is 100 μm or less, printing plates may not be correctly aligned during the printing process due to the expansion of the TPU resin, and thus printing patterns may overlap, causing print clarity to be degraded, or shrinkage may occur after all the semi-finished products are laminated together, and thus curling or doming may occur. On the other hand, when the surface layer 31 is excessively thick, a large loss may occur due to folding occurring during thermal lamination. Therefore, it is advantageous that the thickness of the surface layer 31 is in the range of about 150 μm to 250 μm. In addition, the surface layer 31 may include an additive resin having excellent abrasion resistance at 3 parts by weight to 10 parts by weight relative to 100 parts by weight of the TPU resin and a UV absorber at 1 part by weight to 5 parts by weight relative to 100 parts by weight of the TPU resin.

For example, the additive resin having excellent abrasion resistance may be included in the surface layer 31 at 3, 4, 5, 6, 7, 8, 9, or 10 parts by weight relative to 100 parts by weight of the TPU resin. For example, the UV absorber may be included in the surface layer 31 at 1, 2, 3, 4, or 5 parts by weight relative to 100 parts by weight of the TPU resin.

In embodiments of the present invention, as the UV absorber, one or more selected from the group consisting of a benzotriazole-based UV absorber, a benzophenone-based UV absorber, and a formamidine-based UV absorber may be used, and a formamidine-based UV absorber having relatively excellent light resistance at a wavelength of 290 nm to 330 nm is used.

After mixing the TPU resin, the additive resin having excellent abrasion resistance, and the UV absorber using a kneader or mixer at a temperature of 150° C. to 200° C., that is, above melting points of the resins, and transferring the mixed resin composition from the kneader to an extruder hopper, the resin composition, which is melted at a temperature of 160° C. to 250° C., is extruded through a T-die using a single- or twin-screw extruder so that a sheet is formed. When the temperature of the extruder is less than 160° C., since the resins cannot be sufficiently melted, the resin melting pressure may become excessively high, and the difficulty of extrusion may increase. On the other hand, when the temperature of the extruder is greater than 250° C., the resins can easily melt but may be susceptible to oxidation. In this way, the surface layer 31 is obtained.

Next, in step S12, a surface layer including a printed layer 32 is formed by printing a specific pattern directly on one side of the surface layer 31 by a gravure printing method. This method of printing directly on one side of the surface layer is completely different from the conventional method of printing on white printing paper and laminating a surface layer thereon, and the process is simplified and defects are significantly reduced due to excluding the conventional white printing paper, raw material costs are reduced accordingly, and therefore, economic efficiency is greatly improved.

Next, in step S13, a surface-treatment layer 30 is formed on an upper side of the surface layer including the printed layer, and thereby a semi-finished product 40 is obtained. The surface-treatment layer 30 is used to prevent the property degradation and aging of the flooring material, prevent the contamination and scratching of the flooring material, and facilitate cleaning, and is formed by applying and UV-curing one or more selected among an unsaturated polyester resin-based material, an epoxy acrylate-based material, a urethane acrylate-based material, a polyurethane-based material, and a polyester acrylate-based material or by applying and thermally curing water-based polyurethane. Water-based polyurethane is used. The surface-treatment layer is formed on the other side of the surface layer on which the printed layer is not formed.

Next, steps S14 of forming a core layer 33 including a TPU resin and S15 of forming a balance layer 34 including a TPU resin are performed in the same manner as the method of forming the surface layer 31, by mixing components in the above-described predetermined ratios and forming the mixture into a sheet of a predetermined thickness by T-die extrusion or using calendering equipment. The core layer 33 and the balance layer 34 include a TPU resin having a Shore hardness of 90A to 120A and a softening point of 60° C. to 100° C., a flame retardant, and an inorganic material. The core layer 33 and the balance layer 34 contain the flame retardant at 3 parts by weight to 15 parts by weight relative to 100 parts by weight of the TPU resin, and the flame retardant may be one or more selected from the group consisting of magnesium hydroxide (Mg(OH)₂), aluminum hydroxide (Al(OH)₃), and antimony trioxide (Sb₂O₃).

The inorganic material may be included in the core layer and the balance layer at 50 parts by weight to 150 parts by weight relative to 100 parts by weight of the TPU resin, and may be one or more selected from the group consisting of calcium carbonate, talc, silica, alumina, zinc oxide, and mica.

In embodiments of the present invention, the core layer 33 may further include 50 parts by weight to 100 parts by weight more inorganic material than the weight of the inorganic material included in the balance layer 34. In this case, it is advantageous to add a lubricant to the core layer 33 at 1 part by weight to 5 parts by weight relative to 100 parts by weight of the TPU resin to increase extrusion moldability, and the lubricant may be one or more selected from the group consisting of paraffin wax, a process oil, a vegetable oil, and stearic acid. When the lubricant is used, the heat resistance, flame retardancy, and dimensional stability of the flooring material are increased, and economic efficiency is greatly improved due to the use of an inexpensive inorganic filler. For example, the lubricant may be included in the core layer 33 at 1, 2, 3, 4, or 5 parts by weight.

Next, in step S16, the surface layer 31 including the surface-treatment layer 30 and the printed layer 32, the core layer 33, and the balance layer 34 are wound into rolls and then continuously thermally laminated by emboss lamination. Here, the semi-finished products are laminated together in a continuous process in which the semi-finished products are loaded onto a loading platform in a wound state, passed through an auxiliary preheating drum set to about 130° C. to 150° C. and then embossing equipment including a main heating drum set to 140° C. to 180° C. in the order the semi-finished products are to be laminated, and then thermocompressed.

In step S17, the laminated semi-finished products 50 are passed through an aging region in the form of a plate-shaped belt press in which temperatures of upper and lower regions are adjustable, and cooling the semi-finished products, and thereby a finished product is obtained. The cooling belt press includes two to three zones and is designed such that the cooling belt press zones have independent temperature gradients. In addition, the cooling belt press is designed such that the cooling belt press zones have different upper- and lower-compression-belt temperature gradients. This is because the upper and lower layers of the finished product having different compositions and properties have different coefficients of thermal expansion and it is possible to prevent deformation due to temperature changes and improve dimensional stability by controlling the degrees to which the upper and lower layers of the finished product are cooled. Temperatures in the cooling belt press may be set freely in the temperature range of 20° C. to 150° C., and the cooling belt press may be designed so that upper- and lower-belt temperatures may also be set freely in the temperature range of 20° C. to 150° C. The semi-finished products 50 laminated together while being passed through the embossing equipment and thermocompressed are aged and slowly cooled while being passed through a first zone having a temperature range of 80° C. to 100° C., a second zone having a temperature range of 60° C. to 80° C., and a third zone having a temperature range of 20° C. to 40° C. In this case, setting the lower-belt temperatures of the cooling belt press about 10° C. to 20° C. lower than the upper-belt temperatures may be advantageous in preventing warping of the finished product.

Hereinafter, embodiments of the present invention will be described in more detail by way of exemplary embodiments. However, the exemplary embodiments are merely illustrative of the present invention, and in accordance with the gist of embodiments of the present invention, it will be apparent to those of ordinary skill in the art that the scope of embodiments of the present invention is not limited by the exemplary embodiments.

### Manufacturing of Example 1

Each semi-finished product constituting an eco-friendly TPU flooring material having excellent dimensional stability and abrasion resistance was prepared. A surface layer including a printed layer was formed by mixing a TPU resin having a Shore hardness of 95A and a softening point of 90° C. at 100 parts by weight with a UV absorber at 2 parts by weight and an UHMWPE resin having a molecular weight of 3,000,000 at 3 parts by weight, passing the mixture through an extrusion T-die so that a sheet with a thickness of 0.2 mm was obtained, and printing a specific pattern on one side of the sheet using a water-based urethane ink. A surface-treatment layer was formed by applying a water-based polyurethane resin coating on one side of the surface layer different from the surface on which the specific pattern was printed and heat drying the coating, and thereby a semi-finished product 1 was obtained. A core layer was formed by mixing a TPU resin having a Shore hardness of 95A and a softening point of 90° C. at 100 parts by weight with magnesium hydroxide as a flame retardant at 5 parts by weight, talc as an inorganic material at 200 parts by weight, and a process oil as a lubricant at 1 part by weight, and thereby a semi-finished product 2 having a thickness of 2.1 mm was obtained. A balance layer was formed by mixing a TPU resin having a Shore hardness of 95A and a softening point of 90° C. at 100 parts by weight with magnesium hydroxide as a flame retardant at 5 parts by weight, talc as an inorganic material at 100 parts by weight, and a process oil as a lubricant at 1 part by weight, and thereby a semi-finished product 3 having a thickness of 0.7 mm was obtained.

After the semi-finished products 1, 2, and 3 were sequentially loaded onto a loading platform in a wound state, the semi-finished products 1, 2, and 3 were laminated together in a continuous process in which the semi-finished products were individually passed through an auxiliary preheating drum so that the semi-finished products were preheated to about 130° C., individually passed through embossing equipment including a main heating drum set to 160° C., and then thermocompressed. Subsequently, the resultant was passed through a cooling belt press having upper-roll temperatures of 100° C., 70° C., and 40° C. and lower-roll temperatures of 90° C., 60° C., 30° C. The semi-finished products which have been laminated and aged were cut with cutting machine equipped with a knife mold of a predetermined size, and thereby an eco-friendly flooring material was obtained.

### Manufacturing of Example 2

An eco-friendly flooring material was manufactured in the same manner as in Example 1 except that, in preparing a surface layer including a printed layer, silicone gum at 3 parts by weight was used instead of the UHMWPE resin to prepare a mixture, and the mixture was passed through an extrusion T-die so that a sheet with a thickness of 0.2 mm was obtained.

### Manufacturing of Example 3

An eco-friendly flooring material was manufactured in the same manner as in Example 1 except that, in preparing a surface layer including a printed layer, an UHMWPE resin at 1 part by weight and silicone gum at 1 part by weight were used at the same time instead of the UHMWPE resin alone at 3 parts by weight to prepare a mixture, and the mixture was passed through an extrusion T-die so that a sheet with a thickness of 0.2 mm was obtained.

### Manufacturing of Comparative Example 1

A final eco-friendly flooring material was manufactured in the same manner as in Example 1 except that a TPU resin having a Shore hardness of 77A and a softening point of 80° C. was used instead of the TPU resin having a Shore hardness of 95A and a softening point of 90° C. to form a surface layer.

### Manufacturing of Comparative Example 2

A final eco-friendly flooring material was manufactured in the same manner as in Example 1 except that an UHMWPE resin was not used to form a surface layer.

### Manufacturing of Comparative Example 3

A final eco-friendly flooring material was manufactured in the same manner as in Example 1 except that a cooling belt press process was not performed.

Specimens of the eco-friendly flooring materials manufactured according to Examples 1 to 3 of embodiments of the present invention and Comparative Examples 1 to 3 were manufactured. Also, the appearance conditions, abrasion resistance, flame retardancy, dimensional stability, and anti-curling properties of the eco-friendly flooring materials of Examples 1 to 3 and Comparative Examples 1 to 3 were compared. The properties were evaluated in accordance with the KS M 3802 (PVC (vinyl)-based flooring material), ASTM D 3389 (abrasion resistance measurement method), and UL 94 (horizontal combustion test method) test standards.

The appearance conditions, transparency, abrasion resistance, flame retardancy, dimensional stability, and anti-curling properties of the specimens of the eco-friendly flooring materials manufactured according to Examples and Comparative Examples were evaluated as follows.

### Test 1) Evaluation of Appearance Conditions

The appearance conditions were evaluated in accordance with the KS M 3802 standard, by examining the specimens with the naked eye for defects, ruptures, cracks, cuts, bends, holes, delaminations, wrinkles, curvatures, flexures, abnormal irregularities, inconsistencies in shapes, gloss, and color tones, contamination, flaws, inclusion of foreign substances, etc. and comparing the results with the evaluation criteria shown in Table 1.

TABLE 1

| Classi- | ⊚ | ◯ | Δ | X |
|---|---|---|---|---|
| fication | (Excellent) | (Good) | (Average) | (Poor) |
| Appearance | No defects | 1 to 2 defects | 3 to 5 defects | More than |
| conditions | | at 6 m | at 6 m | 5 defects |
| | | intervals | intervals | at 6 m |
| | | | | intervals |

### Test 2) Evaluation of Abrasion Resistance

The abrasion resistance was evaluated in accordance with the ASTM D3389 standard, by measuring the amount (g) of wear of surface layers of the flooring material specimens under conditions of an H-18 abrasion wheel, 2 kg load, and 1,000 abrasion cycles and comparing the results with the evaluation criteria shown in Table 2.

TABLE 2

| Classi- | ⊚ | ◯ | Δ | X |
|---|---|---|---|---|
| fication | (Excellent) | (Good) | (Average) | (Poor) |
| Amount of | Less than | 0.15 or more and | 0.25 or more and | 0.30 |
| wear (g) | 0.15 | less than 0.25 | less than 0.30 | or more |

### Test 3) Evaluation of Flame Retardancy

The flame retardancy was evaluated by the UL 94 horizontal combustion method, by setting a burner to produce flames at an angle of 45 degrees and applying the flames to the specimens for 30 seconds, measuring the lengths of the specimens burned within a three-inch section for one minute from the time one inch of the specimens had burned, and comparing the results with the evaluation criteria shown in Table 3.

Evaluation of Flame Retardancy (Based on 3 mm Product Thickness)

TABLE 3

| Classi- | ⊚ | ◯ | Δ | X |
|---|---|---|---|---|
| fication | (Excellent) | (Good) | (Average) | (Poor) |
| Burned length | Less than | 40 or more and | 50 or more and | 60 or |
| (mm) | 40 | less than 50 | less than 60 | more |

### Test 4) Evaluation of Dimensional Stability

The dimensional stability was evaluated in accordance with the KS M 3802 standard, by maintaining the flooring material specimens in a dry oven at 80° C. for six hours, measuring the degrees of expansion or shrinkage of the specimens to obtain rates of dimensional change (%), and comparing the results with the evaluation criteria shown in Table 4.

TABLE 4

| Classi- | ⊚ | ◯ | Δ | X |
|---|---|---|---|---|
| fication | (Excellent) | (Good) | (Average) | (Poor) |
| Rate of | Less | 0.05 or more | 0.10 or more | 0.50 |
| dimensional | than 0.05 | and less than | and less than | or more |
| change (%) | | 0.10 | 0.50 | |

### Test 5) Evaluation of Anti-Curling Properties

The anti-curling properties were evaluated in accordance with the KS M 3802 standard, by maintaining the flooring material specimens in a dry oven at 80° C. for six hours and then at room temperature for about one hour, measuring the degrees of warping of the specimens, and comparing the results with the evaluation criteria shown in Table 5.

TABLE 5

| Classi- | ⊚ | ◯ | Δ | X |
|---|---|---|---|---|
| fication | (Excellent) | (Good) | (Average) | (Poor) |
| Degree of | Less than | −0.10 or more | −0.15 or more | −0.20 |
| warping | −0.10 | and less than | and less than | or more |
| (curling)(mm) | | −0.15 | −0.20 | |

The results of evaluating the flooring materials according to the methods of Test 1) to Test 5) are shown in Table 6.

TABLE 6

| | Appearance | Abrasion | Flame | Dimensional | Anti-curling |
|---|---|---|---|---|---|
| Classification | conditions | resistance | retardancy | stability | properties |
| Example 1 | ⊚ | ◯ | ⊚ | ⊚ | ⊚ |
| Example 2 | ⊚ | ◯ | ⊚ | ⊚ | ⊚ |
| Example 3 | ⊚ | ⊚ | ⊚ | ⊚ | ⊚ |
| Comparative | ⊚ | Δ | ⊚ | ◯ | ⊚ |
| Example 1 | | | | | |
| Comparative | ⊚ | X | ◯ | Δ | ⊚ |
| Example 2 | | | | | |
| Comparative | ⊚ | ◯ | ⊚ | Δ | X |
| Example 3 | | | | | |

Referring to Table 6, it can be seen that the flooring material manufactured according to Example 3 of embodiments of the present invention has slightly higher abrasion resistance and almost the same levels of the other properties compared to Examples 1 and 2. In addition, it can be seen that Example 3 exhibits superior properties in terms of all of appearance conditions, abrasion resistance, flame retardancy, dimensional stability, and anti-curling properties as compared to Comparative Examples 1, 2, and 3.

In the above, the specific exemplary embodiments of the TPU flooring material having excellent dimensional stability and abrasion resistance according to embodiments of the present invention have been described, but the embodiments are only exemplary and do not limit embodiments of the present invention thereto, and it is possible, by combining or substituting the disclosed embodiments, to adopt structures not described above, in which case the combination or substitution does not depart from the scope of embodiments of the present invention. In addition, it is possible to easily change or modify the disclosed embodiments based on the present specification, and it is obvious that such changes or modifications are also included in the scope of embodiments of the present invention.

### DESCRIPTION OF REFERENCE NUMERALS

30: surface-treatment layer containing polyurethane resin
31: surface layer containing polyurethane resin
32: printed layer containing polyurethane resin
33: core layer containing polyurethane resin
34: balance layer containing polyurethane resin
40: semi-finished product in which surface-treatment layer and surface layer including printed layer are laminated
50: semi-finished product in which surface-treatment layer, surface layer including printed layer, core layer, and balance layer are laminated

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A polyurethane flooring material in which a surface layer including a surface-treatment layer and a printed layer, a core layer, and a balance layer are sequentially laminated,
wherein the surface layer includes a thermoplastic polyurethane resin having a Shore hardness of 90A to 120A and a softening point of 60° C. to 100° C. and one or more selected from the group consisting of ultra-high-molecular-weight polyethylene having a molecular weight of 1,000,000 to 5,000,000 and silicone gum, and
each of the core layer and the balance layer includes a thermoplastic polyurethane resin having a Shore hardness of 90A to 120A and a softening point of 60° C. to 100° C., a flame retardant, and an inorganic material.

2. The polyurethane flooring material of claim 1, wherein the thermoplastic polyurethane resin is one or more selected from the group consisting of an ester-based thermoplastic polyurethane resin, an ether-based thermoplastic polyurethane resin, and a carbonate-based thermoplastic polyurethane resin.

3. The polyurethane flooring material of claim 1, wherein the surface layer includes one or more selected from the group consisting of ultra-high-molecular-weight polyethylene and silicone gum at 1 part by weight to 10 parts by weight relative to 100 parts by weight of the thermoplastic polyurethane resin and additionally includes a ultraviolet absorber at 1 part by weight to 5 parts by weight relative to 100 parts by weight of the thermoplastic polyurethane resin.

4. The polyurethane flooring material of claim 3, wherein the ultraviolet absorber is one or more selected from the group consisting of benzotriazole, benzophenone, and formamidine.

5. The polyurethane flooring material of claim 1, wherein the printed layer is printed directly on one side of the surface layer using an ink containing a water-based polyurethane component.

6. The polyurethane flooring material of claim 1, wherein the surface-treatment layer is formed of a water-based polyurethane resin having a solid content of 30% to 40% and a viscosity of 10 cps to 200 cps.

7. The polyurethane flooring material of claim 1, wherein the silicone gum is one or more selected from the group consisting of methyl gum, hydroxyl gum, and vinyl gum.

8. The polyurethane flooring material of claim 1, wherein the surface layer includes the ultra-high-molecular-weight polyethylene resin at 1 part by weight to 5 parts by weight and the silicone gum at 1 part by weight to 5 parts by weight relative to 100 parts by weight of the thermoplastic polyurethane resin.

9. The polyurethane flooring material of claim 1, wherein the core layer includes an inorganic material at 100 parts by weight to 250 parts by weight, a flame retardant at 3 parts by weight to 15 parts by weight, and a lubricant at 1 part by weight to 3 parts by weight relative to 100 parts by weight of the thermoplastic polyurethane resin.

10. The polyurethane flooring material of claim 1, wherein the balance layer includes an inorganic material at 50 parts by weight to 100 parts by weight and a flame retardant at 3 parts by weight to 15 parts by weight relative to 100 parts by weight of the thermoplastic polyurethane resin.

11. A method of manufacturing a polyurethane flooring material, comprising:
forming a surface layer containing a thermoplastic polyurethane resin;
printing a pattern directly on one side of the surface layer and forming a printed layer;
applying a water-based polyurethane coating on the other side of the surface layer and forming a surface-treatment layer;
forming a core layer including a thermoplastic polyurethane resin;
forming a balance layer including a thermoplastic polyurethane resin;
sequentially winding the surface layer including the surface-treatment layer and the printed layer, the core layer, and the balance layer into rolls and then continuously thermally laminating the layers by emboss lamination and producing a semi-finished product; and
aging the semi-finished product by passing the semi-finished product through an aging region in a form of a plate-shaped belt press of which temperature is adjustable and cooling the semi-finished product.

12. The method of claim 11, wherein the aging region includes a first zone having a temperature range of 80° C. to 100° C., a second zone having a temperature range of 60° C. to 80° C., and a third zone having a temperature range of 20° C. to 40° C., which are sequentially arranged.
